(19) United States
(12) Patent Application Publication
(10) Pub. No.: US 2004/0125874 A1
(43) Pub. Date: Jul. 1, 2004

(54) Method of determining an eye diagram of a digital signal

(75) Inventor: Wolfgang Baumert, Schwieberdingen (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/720,181

(22) Filed: Nov. 25, 2003

(30) Foreign Application Priority Data
Dec. 30, 2002 (EP) 02 360 382.2

(51) Int. Cl. H04Q 1/20; H04B 3/46

(52) U.S. Cl. 375/226

(57) ABSTRACT

The present invention relates to a method of determining an eye diagram of a digital signal (dat). The method comprises a step of obtaining (110) a first phase difference information corresponding to a first phase difference between said digital signal (dat) and a clock signal (clk) associated to said digital signal (dat), obtaining (120) a second phase difference information corresponding to a second phase difference between said digital signal (dat) and said clock signal (clk), and determining (130) an eye width (T_eye) based on said first phase difference information and said second phase difference information.

### BACKGROUND OF THE INVENTION

The invention is based on a priority application EP02360382.2 which is hereby incorporated by reference.

The present invention relates to a method of determining an eye diagram of a digital signal.

The present invention further relates to a method of controlling an eye width of an eye diagram of a digital signal, an eye monitor for determining an eye width of an eye diagram of a digital signal, and a receiver for receiving a digital signal.

In state-of-the-art communication systems, binary encoded information is usually sent from a transmitter to one or more receivers, wherein a transmission medium usually comprises copper cable, free space and optical fibre. A common goal of said digital communication systems is minimizing the bit error rate.

In order to achieve this goal, digital signal receivers comprise a so-called eye monitor with which a measure for the quality of a transmission channel can be determined. In particular, said eye monitor detects a vertical eye opening which carries information on additive noise, jitter and other adverse effects that affect the shape of the digital signal. Within optical transmission systems, additional errors of the signal shape are caused by polarization mode dispersion (PMD), chromatic distortion and the like.

### SUMMARY OF THE INVENTION

It is an object of the present invention to provide a method of determining an eye diagram of a digital signal, which allows for improved assessment of signal quality.

It is a further object of the present invention to provide an improved eye monitor and a receiver with an improved eye monitor.

According to the present invention, these objects are achieved by determining an eye width of said eye diagram. It has been found out that monitoring said eye width that is corresponding to an horizontal opening of said eye diagram, improves the overall quality of an analysis of a digital signal.

According to an advantageous embodiment of the present invention, said method is characterized by the following steps:

obtaining a first phase difference information corresponding to a first phase difference between said digital signal and a clock signal associated to said digital signal,

obtaining a second phase difference information corresponding to a second phase difference between said digital signal and said clock signal, and

determining said eye width based on said first phase difference information and said second phase difference information.

Since in digital communication systems there is a need for synchronization between the digital signal which represents binary encoded data and the clock signal that provides a time base for electronic circuits processing said digital signal, an assessment of signal quality of said digital signal includes monitoring a phase difference between said digital signal and said clock signal.

In state of the art digital transmission systems, e.g. within a receiver, said clock signal is regenerated by analysing said data signal. A high or rapidly varying phase difference between said digital signal and said clock signal may lead to an increase of the bit error rate, because the digital signal is sampled at a wrong sample time within said receiver. According to the present invention, this is avoided by accurately assessing the eye width in the previously described manner.

A further very advantageous embodiment of the present invention is characterized in that said first phase difference is measured between said digital signal and a rising edge of said clock signal, said rising edge corresponding to a start of a bit time, and in that said second phase difference is measured between said digital signal and a falling edge of said clock signal, said falling edge corresponding to an end of said bit time. Such a measurement is very simple because it can e.g. be triggered by the rising/falling edge of the clock signal.

A very advanced method which is especially useful within digital systems having very high bit rates provides

integrating in a first calculation cycle said first phase difference information of N many subsequent bits of said digital signal to obtain a first phase difference voltage, and, after said first calculation cycle,

integrating in a second calculation cycle said second phase difference information of N further subsequent bits of said digital signal to obtain a second phase difference voltage.

Although it is possible to provide an exact value of a phase difference, it is often sufficient to monitor the sign of the phase difference, i.e. whether the digital signal precedes the clock signal or vice versa. This variant is referred to in the further description without any limitation of the scope of the present invention.

More specifically, said phase difference information can be represented by a binary value, wherein a value of “zero” e.g. denotes a state in which the digital signal precedes the clock signal and wherein a value of “one” denotes a state in which the clock signal precedes the digital signal.

That means, if during said first calculation cycle the digital signal always precedes the clock signal, this yields “zero” as a result of said integration which is equivalent to a corresponding first phase difference voltage of 0 Volts. Otherwise, if during said first calculation cycle the clock signal always precedes the digital signal, this yields N as a result of said integration which is equivalent to a corresponding first phase difference voltage of U_M Volts. Consequently, if the average phase difference is about zero, said integration within said first calculation cycle yields N/2 which corresponds to a phase difference voltage of U_M/2 Volts.

Said second phase difference voltage is determined the same way as is said first phase difference voltage. Hence, it is possible to obtain said first phase difference voltage and said second phase difference voltage by using only one phase detection means. In this case, depending on a trigger condition for the measurement of the phase difference, it may be necessary to cyclically invert said clock signal every N bits to create a proper trigger condition e.g. for obtaining said second phase difference voltage. Said integration is preferably performed by an RC-circuit which is easy to implement for the typical frequency range of the digital signal up to 100 GHz.

Simulations show that the number N can be chosen large enough so as to enable state-of-the-art micro-controllers to evaluate the first and second phase difference voltage after the corresponding calculation cycle, i.e. a further processing of said first phase difference voltage and said second phase difference voltage can easily be performed with standard components.

Apart from that, the number N of subsequent bits processed can be changed during operation of a digital transmission system.

According to a further advantageous embodiment of the present invention, an eye width voltage is determined based on said first phase difference voltage and on said second phase difference voltage, in particular based on a difference between said first phase difference voltage and said second phase difference voltage, said eye width voltage corresponding to said eye width of said eye diagram.

The method according to the present invention is not limited to optical transmission of digital signals. Cable- or radio-based digital signal transmission systems can use the method, too, for obtaining an eye width.

According to a further very advantageous embodiment of the present invention, said first phase difference information and/or said second phase difference information are controllably delayed, preferably by a multiple of a/said bit time. A controllable delay allows for compensation of the time delay between the first N subsequent bits and the second N subsequent bits. This may be desirable when processing said first and said second phase difference information at the same time.

According to another advantageous embodiment of the present invention, said first phase difference information and/or said second phase difference information and/or a bit value information, which is preferably obtained by a decision gate, and/or a phase difference information selection signal are combined, preferably by means of a combinatoric network according to a predefined scheme, and in that an output of said combinatoric network is integrated in said first and/or said second calculation cycle. The combinatoric network e.g. controls the number N of subsequent bits to be analysed within each of said two calculation cycles.

A further solution to the object of the present invention is given by a method of controlling an eye width of an eye diagram of a digital signal, comprising the method of determining said eye diagram according to the invention and comprising a step of adjusting a phase of said clock signal, said adjustment of said phase of said clock signal depending on said eye width. By adjusting the phase of the clock signal, it is possible to influence the eye width i.e. the eye width can e.g. be maximised depending on the phase adjustment. This, in turn, results in a lower bit error rate.

A very advantageous embodiment of the present invention is characterized in that said eye width is used by computation means that control phase adjustment means, preferably electronic phase adjustment means, for said phase adjustment, which provides a very flexible possibility of e.g. minimising the bit error rate. It is also possible to store eye width values within said computer for a predetermined period of time to gather information about the transmission quality of the digital signal.

Another very advantageous embodiment of the present invention uses said eye width for controlling transmission control means, such as polarization mode dispersion (PMD)-mitigation means and the like, which controllably influence electrical and/or optical characteristics of an electrical/optical transmission line that is used for transmitting said digital signal so as to reduce or compensate, respectively, adverse effects deteriorating the digital signal during transmission.

A further very sophisticated variant of the method of the present invention is characterized by deriving time jitter information of said digital signal by means of

analysing a relation between said eye width and a phase difference between said clock signal and said digital signal, and

obtaining time jitter information from a gradient of said eye width with respect to said phase difference and/or from said eye width.

The phase difference can be changed stepwise by e.g. using the aforementioned phase adjustment means, wherein for each phase step the eye width is measured. At a distinct, optimum value of the phase difference, a maximum eye width will be detected. The gradient of said eye width as a function of said phase difference contains information about time jitter.

A further solution to the object of the present invention is represented by an eye monitor for determining an eye width of an eye diagram of a digital signal. According to a variant of the invention, the eye monitor comprises:

phase detection means for obtaining a first phase difference information and a second phase difference information between said digital signal and a clock signal associated to said digital signal,

integration means for integrating said first phase difference information and said second phase difference information to obtain a first phase difference voltage and a second phase difference voltage,

computation means for determining an eye width voltage based on said first phase difference voltage and on said second phase difference voltage, in particular based on a difference between said first phase difference voltage and said second phase difference voltage, said eye width voltage corresponding to said eye width of said eye diagram.

An advantageous embodiment of said eye monitor according to the present invention further comprises phase adjustment means for adjusting a phase of said clock signal. Preferably, said phase adjustment means are of the electric type.

Yet a further solution to the object of the present invention is given by a receiver for receiving a digital signal, characterized by being capable of performing a method according to the invention. The receiver preferably comprises an eye monitor according to the present invention.

### BRIEF DESCRIPTION OF THE DRAWINGS

Further embodiments, features and details of the present invention are explained in the following detailed description with reference to the drawings, wherein

FIG. 1 shows an eye diagram,

FIG. 2a shows a clock signal of a digital transmission system,

FIG. 2b shows a rising edge of a digital signal,

FIG. 2c shows a falling edge of said digital signal of FIG. 2b,

FIG. 3 shows a block diagram of a digital signal receiver according to the present invention,

FIG. 4 shows a schematic drawing of an eye monitor according to the invention,

FIG. 5 shows a block diagram of a method according to the present invention, and

FIG. 6 shows two sequences of subsequent bits of said digital signal.

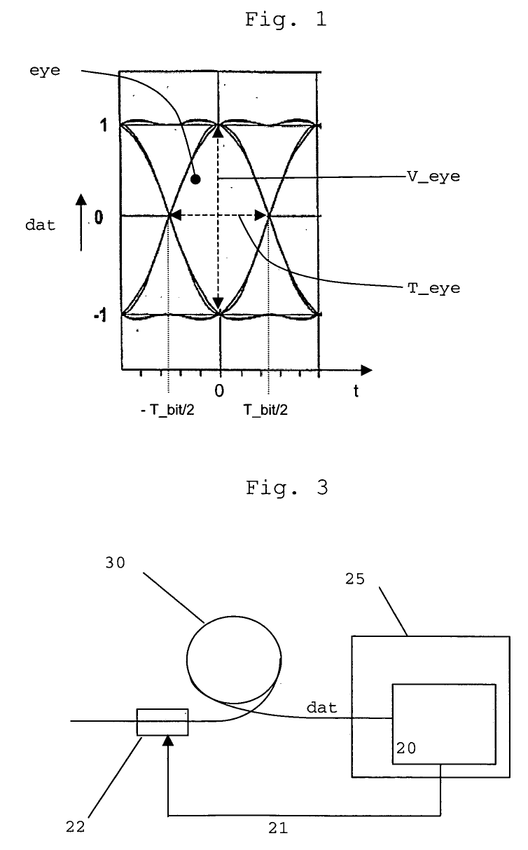

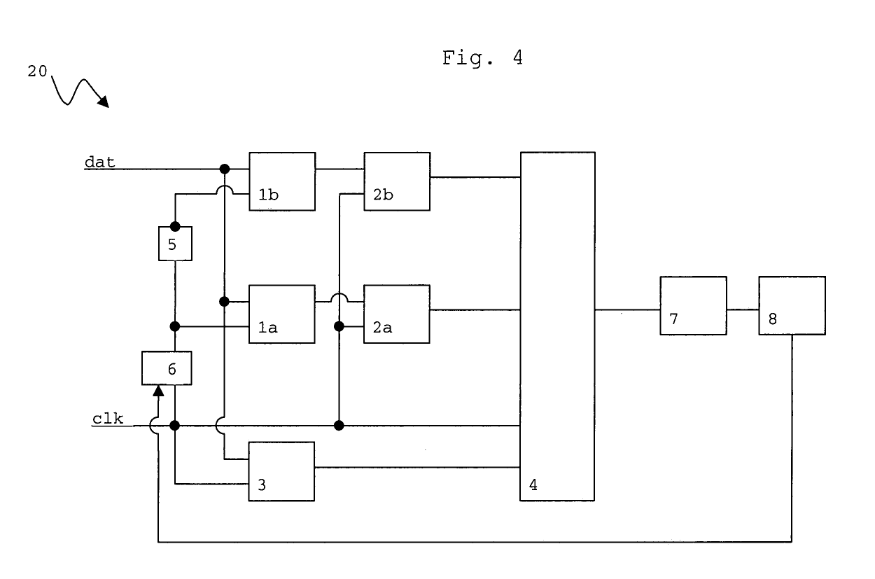

The eye diagram of FIG. 1 comprises an eye that is characterized by an eye width T_eye, which corresponds to a horizontal opening of said eye, and by a vertical eye opening V_eye. Said eye diagram is used in digital transmission systems, an example of a receiver portion of which is shown in FIG. 3, to assess the quality of a digital signal dat (FIGS. 1, 3) which is transmitted over a transmission line 30 (FIG. 3). Although the following description is not limited to optical digital transmission systems, the transmission line 30 shown in FIG. 3 is an optical fibre.

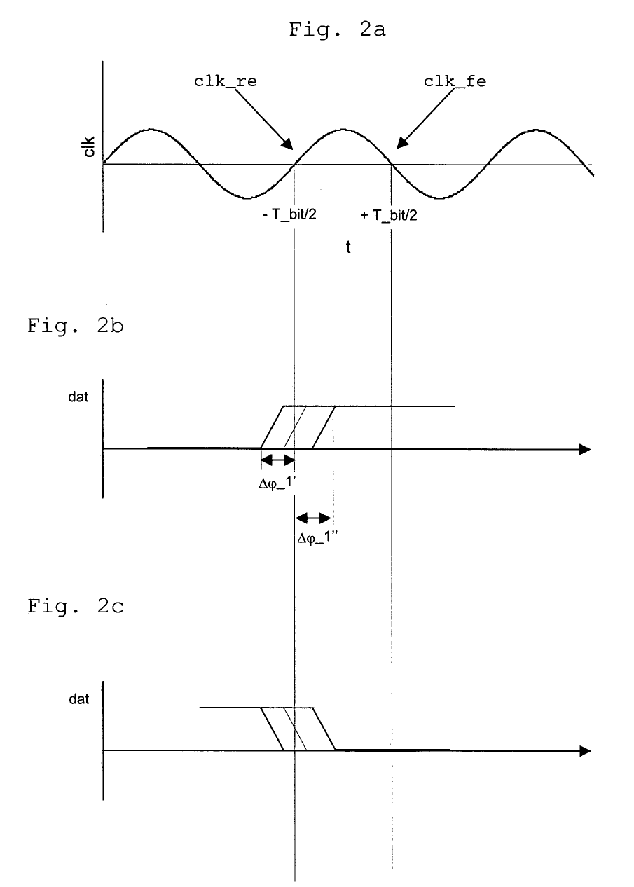

In a receiver 25 of said transmission system, said digital signal dat is converted from an optical signal to an electrical signal, and a clock signal clk (FIG. 2a) is associated to said digital signal dat. Said clock signal clk determines a sample time used for evaluating said digital signal dat within said receiver 25 of FIG. 3. A phase difference between said digital signal dat and said clock signal clk consequently affects the sample time and can thus contribute to an increase of the bit error rate of a receiving process, which is to be avoided.

A poor signal quality of said digital signal dat can be derived from a small eye opening that is due to a small eye width T_eye and/or a small vertical opening V_eye of said eye. A large value of the eye width T_eye and/or the vertical opening V_eye of the eye indicates a good signal quality of said digital signal dat. Both the vertical opening V_eye and the eye width T_eye can be optimised by adjusting the phase difference mentioned above. However, the present invention puts an emphasis to maximising the eye width T_eye.

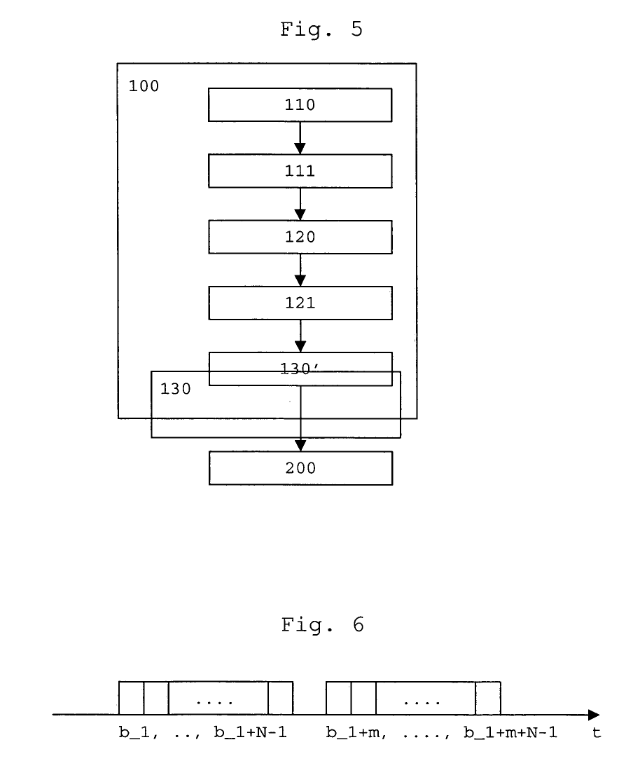

To achieve this object, the receiver 25 is equipped with an eye monitor 20 for obtaining said eye width T_eye of said eye diagram (FIG. 1) which is indicated by step 100 of FIG. 5. A schematic drawing of said eye monitor 20 is shown in FIG. 4.

The eye monitor 20 comprises first and second phase detection means 1a and 1b, both of which receive the digital signal dat as input signal. Said first phase detection means 1a receive the clock signal clk, which is associated to said digital signal dat, as a further input signal. The clock signal clk can be influenced by phase adjustment means 6 which are described in detail further below. Said second phase detection means 1b receive an inverted clock signal that is obtained from inverting said clock signal clk by means of an inverter 5 as a further input signal.

Both phase detection means 1a and 1b are operating in the same way. Therefore, phase detection means operation is described with respect to said first phase detection means 1a and can be transferred to said second phase detection means 1b hereafter without any constraints.

As already mentioned, said first phase detection means 1a receive said digital signal dat and said clock signal clk as input signals. A detailed drawing of the clock signal clk is presented in FIG. 2a. Additionally, an exemplary portion of the digital signal dat is shown in FIG. 2b.

More precisely, said exemplary portion of the digital signal dat shown in FIG. 2b represents a low-to-high transition of the digital signal dat.

At its output, the first phase detection means la outputs a first phase difference information which represents a phase difference between said input signals, i.e. between said digital signal dat and said clock signal clk. In the block diagram of FIG. 5, obtaining said first phase difference information is represented by step 110.

The first phase difference information is binary coded and contains within one bit the information about whether the clock signal clk precedes the digital signal dat or vice versa. In FIG. 2b, three corresponding cases with respect to the phase difference between said clock signal clk and said digital signal dat are shown.

In the first case, the digital signal dat precedes the clock signal clk, since there is a phase difference of _{ΔΦ}_{_{—}}1′ between a rising edge clk_re of the clock signal clk (FIG. 2a) and the digital signal dat. In the second case, the clock signal clk precedes the digital signal dat, since there is a phase difference of _{ΔΦ}_{_{—}}1″ between the rising edge clk_re of the clock signal clk and the digital signal dat. The third case is indicated by a dashed line with the low-to-high transition of the digital signal dat corresponding to the instant designated −T_bit/2 within FIG. 2a. In said third case, there is virtually no phase difference between the clock signal clk and the digital signal dat.

If the digital signal dat precedes the clock signal clk, the first phase difference information which is output by said first phase detection means 1a has the value “zero”. Otherwise, if the clock signal clk precedes the digital signal dat, said first phase difference information has the value “one”. The third case, i.e. if there is no phase difference between said digital signal dat and said clock signal clk, is characterized by statistically yielding the same number of “zero”-values and “one”-values for a plurality of measurements.

Since the left eye boundary of the eye diagram (FIG. 1) is defined by a plurality of rising and falling edges, the phase measurements within said first phase detection means described above are not only conducted for low-to-high transitions of the digital signal dat but also for high-to-low transitions of the digital signal dat, one of which is indicated by the exemplary portion of the digital signal dat shown in FIG. 2c. For such a high-to-low transition, the output values of the first phase detection means 1a are of the same type as with the previously described low-to-high transitions of the digital signal dat.

The operation of the second phase detection means 1b is highly similar. The only difference consists in the reference time which is used for calculating a phase difference. This reference time is +T_bit/2, i.e. in contrast to said first phase detection means 1a it corresponds with a falling edge clk_fe of the clock signal clk. Nevertheless, the structure of the second phase detection means 1b need not be changed as compared to the first phase detection means 1a since the clock signal clk is inverted by the inverter 5 of FIG. 4 which turns a falling edge clk_fe of said clock signal clk into a rising edge clk_re and vice versa.

Altogether, the first phase difference information obtained by said first phase detection means 1a is related to the left boundary of the eye of FIG. 1, and the second phase difference information obtained by said second phase detection means 1b within step 120 (FIG. 5) is related to the right boundary of the eye.

The phase detection is done sequentially, i.e. for a predefined number N of subsequent bits b_{—}1, . . . , b_{—}1+N−1 (cf. FIG. 6), which defines a first calculation cycle, the first phase difference information is obtained which results in a number N of phase difference information items that can have a value of “zero” or “one” in accordance with the above explanations. These N phase difference information items are integrated in step 111 of FIG. 5 within the integration means 7 of FIG. 4, which results in a first phase difference voltage U_{^{—}}_{ΔΦ}_{_{—}}1 at the output of the integration means 7. Said integration means 7 advantageously comprise an RC-circuit which is easy to implement with very high signal frequencies.

The elements of FIG. 4 designated with the reference numerals 2a, 2b will be explained later and do not affect the routing of the phase difference information from the output of the phase detection means 1a, 1b to the integration means 7. A combinatoric network 4 is provided for selecting one of the first phase difference information and the second phase difference information to be output to said integration means 7. The function of said combinatoric network 4 is explained in detail further below.

The first phase difference voltage U_{^{—}}_{ΔΦ}_{_{—}}1 can attain values ranging from 0 V to U_M. A first phase difference voltage U_{^{—}}_{ΔΦ}1 of 0 V denotes a state in which each of said N bits b_{—}1, . . . , b_{—}1+N−1 has the same phase difference between the digital signal dat and the clock signal clk, wherein the digital signal dat precedes the clock signal clk. In turn, with a first phase difference voltage U_{^{—}}_{ΔΦ}_{_{—}}1 value of U_M, the clock signal clk preceding the digital signal dat is indicated. Intermediate values of the first phase difference voltage U_{^{—}}_{ΔΦ}_{_{—}}1 correspondingly represent states with other phase differences within said first calculation cycle.

After said N subsequent bits b_{—}1, . . . , b_{—}1+N−1, the combinatoric network 4 is triggered by a phase difference information selection signal, that causes the second phase difference information, which has been obtained in step 120 of FIG. 5, to be output to said integration means 7, which defines a second calculation cycle. Before that, said integration means 7 may be reset.

In said second calculation cycle that is represented by step 121 of FIG. 5, N further subsequent bits b_{—}1+m, . . . , b_{—}1+m+N−1 of said digital signal dat are integrated which results in a second phase difference voltage U_{^{—}}_{ΔΦ}_{_{—}}2 at the output of the integration means 7.

Both phase difference voltages U_{^{—}}_{ΔΦ}_{_{—}}1 and U_{^{—}}_{ΔΦ}_{_{—}}2 are stored within computation means 8, wherein said first phase difference voltage U_{^{—}}_{ΔΦ}_{_{—}}1 is stored after the first integration cycle and the second phase difference voltage U_{^{—}}_{ΔΦ}_{_{—}}2 is stored after the second integration cycle. As already mentioned, said integration means 7 can be reset before said second calculation cycle.

After the second integration cycle, said computation means 8 determine an eye width voltage U_w_eye within step 130′ of FIG. 5 by subtracting the first phase difference voltage U_{^{—}}_{ΔΦ}_{_{—}}1 from the second phase difference voltage U_{^{—}}_{ΔΦ}_{_{—}}2. The eye width voltage U_w_eye is proportional to the eye width T_eye, which is thereby accordingly obtained within step 130, cf. FIG. 1, 5. Therefore, the eye width voltage U w eye can be used to assess the eye opening and hence the signal quality of said digital signal dat.

According to a variant of the invention, it is not necessary to perform the aforementioned subtraction of said phase difference voltages U_{^{—}}_{ΔΦ}_{_{—}}1 and U_{^{—}}_{ΔΦ}_{_{—}}2, because the information obtained by said subtraction can also be obtained by not resetting said integration means 7 after said first calculation cycle which leads to an aggregation of said phase difference information items of both said first and said second phase difference information.

To reduce the bit error rate within the receiver 25 of FIG. 3, a variant of the invention provides controlling the eye width T_eye. This is achieved by monitoring the eye width T_eye and by systematically adjusting a phase of said clock signal clk with respect to said digital signal dat so as to minimize a phase difference between said digital signal dat and said clock signal clk. Said adjustment is represented by step 200 of FIG. 5.

The adjustment of the phase of said clock signal clk is performed by supplying phase adjustment means 6 (FIG. 4) with a corresponding phase adjustment value. The control of the eye width T_eye can be performed by said computation means 8, which in this case can also provide said phase adjustment means 6 with the phase adjustment value.

A further embodiment of the invention includes using said eye width T_eye for controlling transmission control means 22, which controllably influence electrical and/or optical characteristics of the transmission line 30. As can be gathered from FIG. 3, the transmission control means 22 are controlled by the eye monitor 20 via a control line 21. More precisely, the transmission control means 22 are controlled by the computation means 8 (FIG. 4) of the eye monitor 20.

The transmission control means 22 may comprise polarisation mode dispersion (PMD)-mitigation means that can alter the optical characteristics of the transmission line 30 so as to increase the eye width T_eye which results in a decreased bit error rate.

A further advantageous variant of the present invention enables deriving information on time jitter of said digital signal dat or said clock signal clk, respectively. This is achieved by analysing a relation between the eye width T_eye and the phase difference between said clock signal clk and said digital signal dat. From the gradient of said eye width T_eye with respect to the phase difference, a measure for the time jitter of said signal(s) dat, clk can be derived. Said gradient can be obtained by changing the phase difference with said phase adjustment means 6 (FIG. 4), storing the corresponding eye width values and by calculating the gradient hereafter.

Yet a further variant of the invention provides delay means 2a, 2b, which controllably delay said first and/or said second phase difference information, preferably by a multiple of said bit time T_bit. This is desirable when processing said first and said second phase difference information at the same time.

A decision gate 3 which is supplied with said clock signal clk and said data signal dat outputs a bit value of said digital signal dat to said combinatoric network 4. The information of said bit value can e.g. be used for verifying phase information obtained by said phase detection means 1a, 1b.

1. Method of determining an eye diagram of a digital signal, wherein by determining an eye width of said eye diagram.

2. Method according to claim 1, wherein by the following steps:
obtaining a first phase difference information corresponding to a first phase difference between. said digital signal and a clock signal associated to said digital signal,
obtaining a second phase difference information corresponding to a second phase difference between said digital signal and said clock signal,
determining said eye width based on said first phase difference information and said second phase difference information.

3. Method according to claim 2, wherein said first phase difference is measured between said digital signal and a rising edge of said clock signal, said rising edge corresponding to a start of a bit time, and in that said second phase difference is measured between said digital signal and a falling edge of said clock signal, said falling edge corresponding to an end of said bit time.

4. Method according to claim 2 or 3, wherein by the following steps:
integrating in a first calculation cycle said first phase difference information of N many subsequent bits of said digital signal to obtain a first phase difference voltage, and, after said first calculation cycle,
integrating in a second calculation cycle said second phase difference information of N further subsequent bits of said digital signal to obtain a second phase difference voltage.

5. Method according to claim 4, wherein by determining an eye width voltage based on said first phase difference voltage and on said second phase difference voltage, in particular based on a difference between said first phase difference voltage and said second phase difference voltage, said eye width voltage corresponding to said eye width of said eye diagram.

6. Method according to one of the preceding claims, wherein said digital signal is transmitted via an electrical or/and optical transmission line or via a radio link.

7. Method according to one of the claims 2 to 6, wherein said first phase difference information and/or said second phase difference information are controllably delayed, preferably by a multiple of a/said bit time.

8. Method according to one of the claims 2 to 7, wherein said first phase difference information and/or said second phase difference information and/or a bit value information, which is preferably obtained by a decision gate, and/or a phase difference information selection signal are combined, preferably by means of a combinatoric network according to a predefined scheme, and in that an output of said combinatoric network is integrated in said first and/or said second calculation cycle.

9. Method of controlling an eye width of an eye diagram of a digital signal, comprising a method of determining said eye diagram according to one of the preceding claims and comprising a step of adjusting a phase of said clock signal, said adjustment of said phase of said clock signal depending on said eye width.

10. Method according to claim 9, wherein said eye width is used by computation means that control phase adjustment means, preferably electronic phase adjustment means, for said adjustment.

11. Method according to claim 9 or 10, wherein by using said eye width for controlling transmission control means, such as polarization mode dispersion-mitigation means and the like, which controllably influence electrical and/or optical characteristics of an electrical/optical transmission line that is used for transmitting said digital signal.

12. Method according to one of the claims 9 to 11, wherein by maximizing said eye width.

13. Method according to one of the claims 9 to 12, wherein by deriving time jitter information of said digital signal by means of
analysing a relation between said eye width and a phase difference between said clock signal and said digital signal, and
obtaining time jitter information from a gradient of said eye width with respect to said phase difference and/or from said eye width.

14. Eye monitor for determining an eye diagram of a digital signal, wherein by determining an eye width of said eye diagram.

15. Eye monitor according to claim 14 , comprising:
phase detection means for obtaining a first phase difference information and a second phase difference information between said digital signal and a clock signal associated to said digital signal,
integration means for integrating said first phase difference information and said second phase difference information to obtain a first phase difference voltage and a second phase difference voltage,
computation means for determining an eye width voltage based on said first phase difference voltage and on said second phase difference voltage, in particular based on a difference between said first phase difference voltage and said second phase difference voltage, said eye width voltage corresponding to said eye width of said eye diagram.

16. Eye monitor according to claim 15, further comprising phase adjustment means for adjusting a phase of said clock signal.

17. Receiver for receiving a digital signal, wherein by being capable of performing a method according to one of the claims 1 to 13.

18. Receiver according to claim 17, wherein by comprising an eye monitor according to one of the claims 14 to 16.
